(19) United States
(12) Patent Application Publication
(10) Pub. No.: US 2025/0234154 A1
(43) Pub. Date: Jul. 17, 2025

(54) INFORMATION PROCESSING DEVICE AND SYSTEM

(71) Applicant: TOYOTA JIDOSHA KABUSHIKI KAISHA, Toyota-shi (JP)

(72) Inventor: Kazuya NISHIMURA, Anjo-shi (JP)

(73) Assignee: TOYOTA JIDOSHA KABUSHIKI KAISHA, Toyota-shi (JP)

(21) Appl. No.: 18/911,269

(22) Filed: Oct. 10, 2024

(30) Foreign Application Priority Data
Jan. 12, 2024 (JP) 2024-003221

(51) Int. Cl. H04W 4/021; G06F 21/62

(52) U.S. Cl. CPC H04W 4/021; G06F 21/62

(57) ABSTRACT

A control unit configured to execute, in response to a fact that a rectangular traveling area including a longitude minimum value, a longitude maximum value, a latitude minimum value, and a latitude maximum value and a geofence area do not overlap with each other, a notification for permitting upload of imaging data corresponding to an event to the vehicle, among time-series position information in a predetermined time before and after occurrence of an event in the vehicle.

### CROSS-REFERENCE TO RELATED APPLICATION

This application claims priority to Japanese Patent Application No. 2024-003221 filed on Jan. 12, 2024, incorporated herein by reference in its entirety.

### BACKGROUND

### 1. Technical Field

The present disclosure relates to an information processing device and a system.

### 2. Description of Related Art

Japanese Unexamined Patent Application Publication (Translation of PCT Application) No. 2018-500618 (JP 2018-500618 A) discloses receiving a map fence set by a user or a merchant. Projected coordinates of the map fence are acquired. The projected coordinates are converted into geographic coordinates. A geographic location area included in the corresponding geofence is acquired based on the geographic coordinates.

### SUMMARY

An object of the present disclosure is to more easily perform a process of determining whether image capture has been performed in a geofenced area where data upload from a vehicle is restricted.

An aspect of the present disclosure provides an information processing device including a control unit configured to transmit a notification to permit upload of captured image data corresponding to an event to a vehicle in response to there not being an overlap between a rectangular travel area and a geofenced area, the travel area including a minimum longitude value, a maximum longitude value, a minimum latitude value, and a maximum latitude value among time-series position information for a predetermined time before and after occurrence of the event in the vehicle.

Another aspect of the present disclosure provides
a system including: a vehicle including a first control unit; and
a server including a second control unit, in which:
the first control unit is configured to
extract a minimum longitude value, a maximum longitude value, a minimum latitude value, and a maximum latitude value as four vertexes, among time-series position information for a predetermined time before and after occurrence of an event, in response to the occurrence of the event,
transmit a request for permission to upload captured image data corresponding to the event to the server, together with information about the four vertexes, and
upload the captured image data to the server in response to receiving a notification of permission to upload the captured image data from the server; and
the second control unit is configured to
determine whether there is an overlap between a rectangular travel area including the four vertexes as vertexes and a geofenced area in response to receiving a request for permission to upload the captured image data from the vehicle, and
transmit a notification of permission to upload the captured image data corresponding to the event to the vehicle in response to an absence of the overlap.

Other aspects of the present disclosure provide an information processing method that causes a computer to execute the above information processing, a program that causes a computer to execute the information processing method, and a computer-readable storage medium storing the program in a non-transitory manner.

According to the present disclosure, it is possible to more easily perform a process of determining whether image capture has been performed in a geofenced area where data upload from a vehicle is restricted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating an example of a configuration of each of a vehicle and a server constituting a system according to a first embodiment;

FIG. 2 is a diagram illustrating a relationship between a traveling area and a geofence area when an event occurs in a vehicle;

FIG. 3 is a diagram illustrating a table configuration of a vehicle-information DB;

FIG. 4 is a sequence diagram showing the overall processing of the system according to the first embodiment;

FIG. 5 is a flow chart showing a process executed in the server according to the first embodiment; and

FIG. 6 is a flowchart illustrating a process executed in the vehicle according to the first embodiment.

### DETAILED DESCRIPTION OF EMBODIMENTS

A control unit of an information processing device according to an aspect of the present disclosure includes:

In the position information of the time series in a predetermined time before and after the occurrence of the event in the vehicle, a notification for permitting the upload of the imaging data corresponding to the event is transmitted to the vehicle in response to the fact that the traveling area of the rectangle including the minimum value of the longitude, the maximum value of the longitude, the minimum value of the latitude, and the maximum value of the latitude does not overlap with the geofence area.

The event refers to the occurrence of a behavior exceeding a normal range among the behavior of the vehicle or the driver, for example. The occurrence of an event corresponds to, for example, the occurrence of a sudden brake, the occurrence of a sudden steering wheel, the occurrence of an impact of a predetermined value or more, and the like. In these cases, it is considered preferable to leave the situation before and after that as imaging data. However, in a military facility, a private load, or the like, it may not be preferable to leave imaging data. Therefore, the geofence area is set so that the data captured in the geofence area is not uploaded. However, when it is determined whether each of the plurality of pieces of position information before and after the occurrence of the event is in the geofence area, the processing amount increases and the cost of the server increases.

Therefore, the control unit permits the upload of the imaging data in response to the fact that the travel area of the rectangle including the minimum value of longitude, the maximum value of longitude, the minimum value of latitude, and the maximum value of latitude and the geofence area do not overlap with each other among the position information of the time series in a predetermined time before and after the occurrence of the event in the vehicle. The travel area may be the smallest rectangle including all time-series position information. Each side of the traveling area may be parallel to a latitude line or a meridian line. Therefore, when the traveling area overlaps with the geofence area, there is a high possibility that the vehicle travels in the geofence area before and after the occurrence of the event. In such a case, upload of the imaging data corresponding to the event is not permitted. On the other hand, if the traveling area and the geo-fence area do not overlap each other, it cannot be said that the vehicle travels in the geo-fence area before and after the occurrence of the event. Therefore, in such a case, a notification for permitting upload of the imaging data corresponding to the event is transmitted to the vehicle. In this way, the processing amount can be reduced by setting the travel area which is the smallest rectangle including all the time-series position information and comparing it with the geofence area.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### First Embodiment

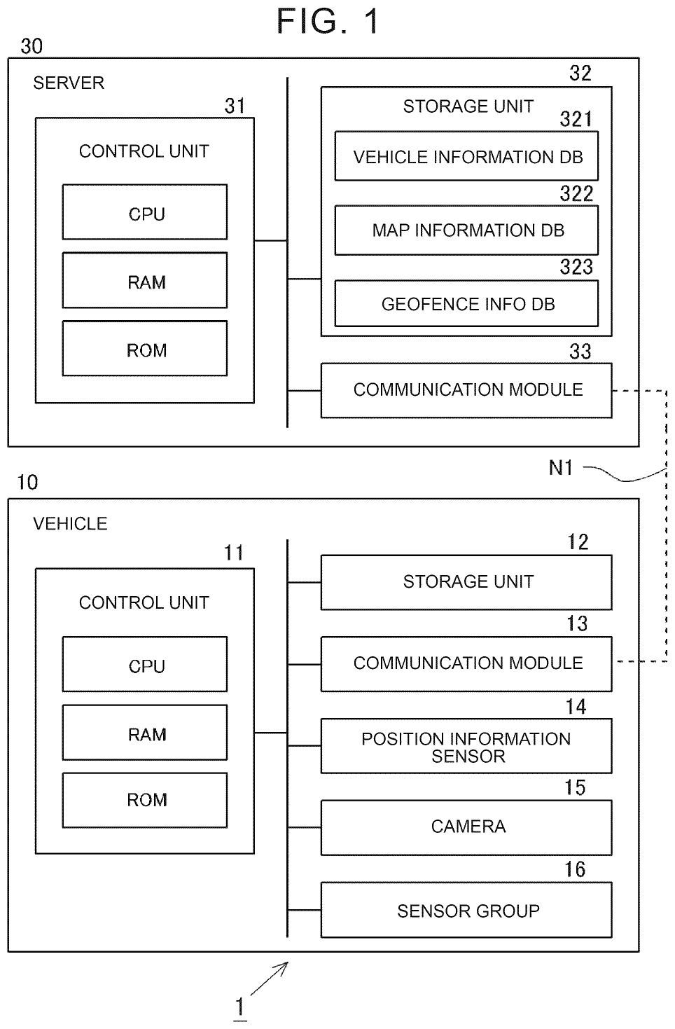

FIG. 1 is a block diagram schematically illustrating an example of a configuration of each of a vehicle 10 and a server 30 constituting the system 1 according to the first embodiment. In the example of FIG. 1, the system 1 includes a vehicle 10 and a server 30. Although FIG. 1 exemplarily illustrates one vehicle 10, there may be a plurality of vehicles 10 without being limited thereto. The vehicle 10 and the server 30 are connected together via a network N1. The network N1 is, for example, a world-wide public communication network such as the Internet, and a wide area network (WAN) or other communication networks may be adopted. In addition, the network N1 may include a telephone communication network such as a mobile phone network and a wireless communication network such as Wi-Fi (registered trademark).

When an event occurs, the vehicle 10 transmits imaging data of a predetermined time before and after the event occurrence time (for example, from 10 seconds before the event occurrence to 10 seconds after the event occurrence) to the server 30. On the other hand, even when an event occurs, the server 30 transmits a notification to the vehicle 10 so as not to upload the imaging data captured in the geofence area. Therefore, the server 30 simply determines whether the vehicle 10 has traveled in the geofence area at a predetermined time before and after the event occurrence time.

FIG. 2 is a diagram illustrating a relationship between a traveling area and a geofence area when an event occurs in the vehicle 10. The lines indicated by L1 in FIG. 2 indicate the travel routes of the vehicle 10. A circle mark on the travel route L1 is a position of the vehicle 10 periodically detected by the position information sensor 14 of the vehicle 10. Further, the circle mark is a position corresponding to a predetermined time (for example, 10 seconds each before and after) before and after the time when an event occurs in the vehicle 10. The position information also includes time information, and the circle in FIG. 2 corresponds to time-series position information. The position of the vehicle 10 is shown in longitude and latitude. In FIGS. 2, (X1, Y1), (X2, Y2), and (X3, Y3) represent the longitude and latitude at that point. In addition, A1 is an area defined by meshes, and A2 is a geofence area. A3 is an area defined by the minimum longitude, the maximum longitude, the minimum latitude, and the maximum latitude among the positions represented by the circles shown in FIG. 2. A3 is hereinafter referred to as a traveling area. In the embodiment shown in FIG. 2, the minimum longitude is X3, the maximum longitude is X2, the minimum latitude is Y1, and the maximum latitude is Y3. The traveling area A3 is an area surrounded by a longitude line passing through the minimum longitude X3, a longitude line passing through the maximum longitude X2, a latitude line passing through the minimum latitude Y1, and a latitude line passing through the maximum latitude Y3. The traveling area A3 is an area defined by the minimum longitude, the maximum longitude, the minimum latitude, and the maximum latitude of the position where the vehicle 10 has passed in a predetermined period before and after the event has occurred. In addition, the traveling area A3 is formed so as to be the smallest rectangle including all the positions of the vehicle 10 at predetermined times before and after the occurrence of the event among the rectangles including the latitude line and the meridian line.

In the present embodiment, the server 30 determines whether there is an area where the traveling area A3 and the geofence area A2 overlap. The overlapping areas are hatched areas in FIG. 2. When the overlapping area exists, it is considered that the vehicle 10 travels in the geofence area at a predetermined time before and after the event occurrence time. Then, in response to the presence of the overlapping area, the server 30 transmits a notification to the vehicle 10 so as not to upload the data corresponding to the event.

The configuration of the server 30 shown in FIG. 1 will be described. The server 30 includes a control unit 31, a storage unit 32, and a communication module 33. The server 30 can be configured as a computer including a processor (such as a CPU, GPU), a main storage device (such as a RAM, ROM), and a secondary storage device (such as an EPROM, a hard disk drive, and a removable medium). The secondary storage device stores an operating system (OS), various programs, various tables, and the like. By executing the program stored therein, it is possible to realize each function (software module) that meets a predetermined purpose, as will be described later. However, some or all of the modules may be realized as hardware modules by, for example, hardware circuitry such as an ASIC, FPGA.

The control unit 31 is an arithmetic unit that realizes various functions of the server 30 by executing a predetermined program. The control unit 31 can be realized by, for example, a hardware processor such as a CPU. In addition, the control unit 31 may be configured to include a RAM, a read only memory (ROM), a cache memory, and the like. Details of the control unit 31 will be described later. The control unit 31 is an example of a second control unit.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB 321, map information DB 322, and geofence information DB 323) is constructed in the storage unit 32, and vehicle information, map information, and geofence information are stored in the database.

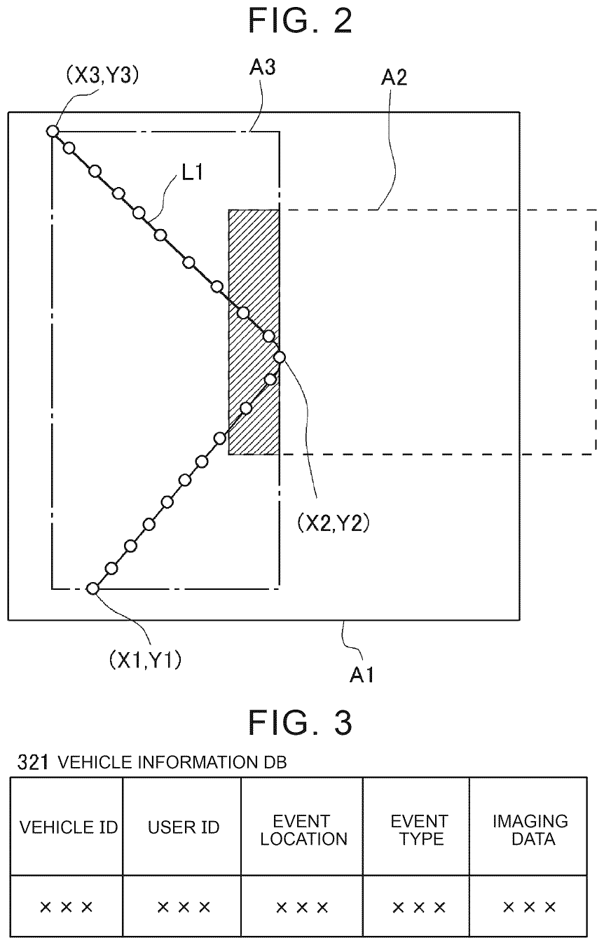

FIG. 3 is a diagram exemplifying a table configuration of the vehicle information DB 321. The vehicle information DB 321 includes fields of a vehicle ID, a user ID, an event occurrence position, an event type, and imaging data. In the vehicle ID field, information (vehicle ID) capable of identifying the vehicle 10 is stored. In the user ID field, information (user ID) capable of identifying the user is stored. In the event occurrence position field, a plurality of pieces of position information within a predetermined time (for example, 10 seconds) before and after the time point at which the event occurs are stored. In the vehicle 10, position information is stored periodically (for example, every second). In the event type field, information about the type of the event that has occurred is stored. An event is an event that is considered desirable to be recorded, such as a sudden braking, a sudden steering wheel, or the like, in which an operation exceeding a normal range is detected, or in which a predetermined impact is detected. The type of the event may be determined by the control unit 31 of the server 30 according to, for example, the detection value of the sensor received from the vehicle 10, or may be determined by the control unit 11 of the vehicle 10. In the imaging data field, information related to imaging data corresponding to the event occurrence position is stored. In the imaging data field, imaging data may be stored, and information about a place where the imaging data is stored may be stored. The imaging data is, for example, moving image data captured by the vehicle 10 at a predetermined time before and after the occurrence of the event.

In addition, the map information DB 322 stores map information including information on meshes. The map information includes, for example, information on longitude and latitude that define the mesh. Note that the map information DB 322 may be provided from another system connected to the network N1, for example, a geographic information system (GIS). Further, the map information may include link data relating to a road (link), node data relating to a node point, intersection data relating to each intersection, search data for searching a route, facility data relating to a facility, search data for searching for a point, and the like.

In addition, the geofence information DB 323 stores information on the geofence area A2. For example, information capable of specifying the position of the geofence area A2 is stored. This information may be input from another terminal.

The communication module 33 is a communication interface for connecting the server 30 to the network N1. The communication module 33 may be configured to include, for example, a network interface board, a wireless communication interface for wireless communication, and the like. The server 30 can perform data communication with each vehicle 10 via the communication module 33.

Note that the specific hardware configuration of the server 30 can be omitted, replaced, or added as appropriate depending on the embodiment.

Next, the vehicle 10 will be described. The vehicle 10 includes a control unit 11, a storage unit 12, a communication module 13, a position information sensor 14, a camera 15, and a sensor group 16. These components are connected to each other by a CAN bus, which is a bus of an in-vehicle network. These components may be components such as a data communication module (DCM), a head unit, a navigational device, an air conditioning system, and a traveling system.

The control unit 11 is an arithmetic unit that realizes various functions of the vehicle 10 by executing a predetermined program. The control unit 11 can be realized by, for example, a hardware processor such as a CPU. In addition, the control unit 11 may be configured to include a RAM, a read only memory (ROM), a cache memory, and the like. The control unit 11 is an example of a first control unit.

The storage unit 12 is a unit that stores information, and is configured by a storage medium such as a RAM, a magnetic disk, or a flash memory. The storage unit 12 stores a program executed by the control unit 11, data used by the program, and the like. The storage unit 12 stores position information periodically acquired by the position information sensor 14.

The communication module 13 is a communication unit for connecting the vehicle 10 to the network N1. In the present embodiment, the vehicle 10 can communicate with other devices (for example, server 30) over a network N1 using a mobile communication service such as 3G, LTE, 5G, 6G.

The position information sensor 14 acquires position information (for example, latitude and longitude) of the vehicle 10. The position information sensor 14 is, for example, a global positioning system (GPS) receiver, a radio communication unit, or the like. The camera 15 is a device that performs imaging using an imaging device such as, for example, a charge coupled device (CCD) image sensor or a complementary metal oxide semiconductor (CMOS) image sensor. A captured image may be any of a still image and a moving image. There may be a plurality of cameras 15. For example, the camera 15 may capture an image of the front and the rear of the vehicle 10.

The sensor group 16 includes a sensor that detects that an event has occurred in the vehicle 10. The sensor group 16 includes, for example, a sensor that detects a state of the vehicle 10, a sensor that detects an operation of the driver, and the like. The sensor group 16 includes, for example, a speed sensor, an acceleration sensor, an accelerator operation amount sensor for detecting the position of the accelerator pedal, a brake sensor for detecting the position of the brake pedal, a handle angle sensor for detecting the angle of the handle, an engine rotational speed sensor for detecting the rotational speed of the engine, a yaw rate sensor, a winker switch sensor (a sensor for detecting the state of the switch of the direction indicator), a shift position sensor, and the like. In addition, the sensor group 16 may include a sensor that detects that a system such as pre-crash safety is activated. Further, the position information sensor 14 may be included in the sensor group 16.

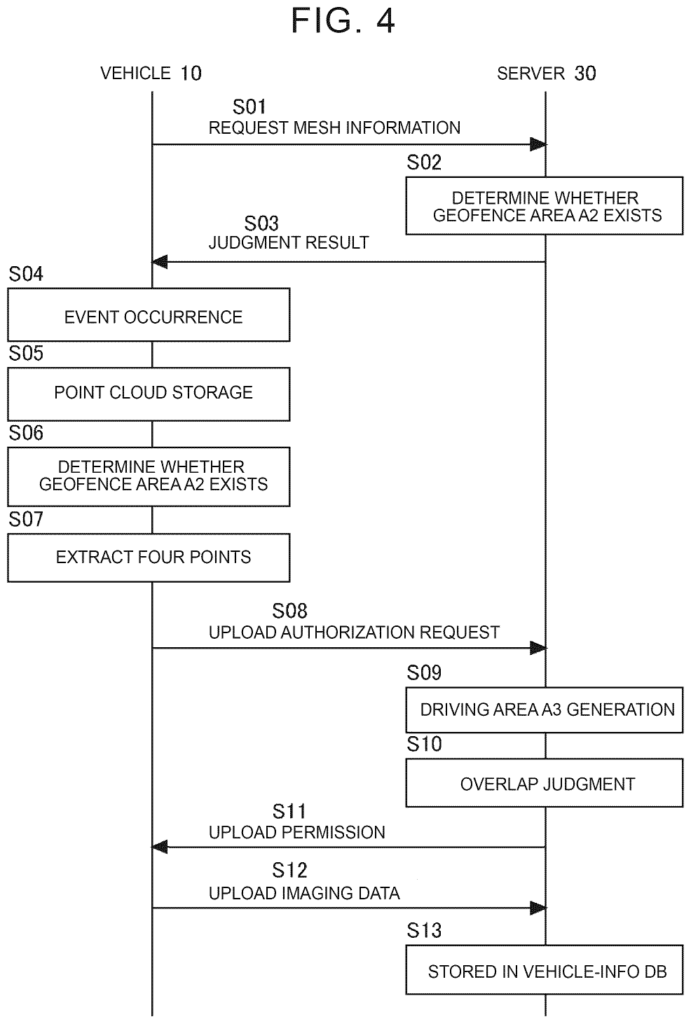

Next, overall processes of the system 1 will be described. FIG. 4 is a sequence diagram illustrating an overall process of the system 1 according to the first embodiment. FIG. 4 exemplarily illustrates a case where there is no overlap between the traveling area A3 and the geofence area A2. The control unit 11 of the vehicle 10 requests information (hereinafter, also referred to as mesh information) related to the mesh from the server 30 (S01). This request may be made, for example, every predetermined time or every time the vehicle 10 enters a new mesh. This request is transmitted along with the location information of the vehicle 10 or information about the mesh of interest. Upon receiving the request for the mesh information from the vehicle 10, the control unit 31 of the server 30 determines whether the geofence area A2 exists in the mesh A1 including the present position of the vehicle 10 (S02). The control unit 31 of the server 30 refers to the geofence information DB 323 and determines whether the geofence area A2 exists in the mesh A1 including the present position of the vehicle 10. The control unit 31 of the server 30 transmits a notification related to the determination result to the vehicle 10 (S03). The determination result is stored in the storage unit 12 of the vehicle 10.

In addition, the control unit 11 of the vehicle 10 detects the occurrence of an event based on the detection value of the sensor group 16 (S04). In response to detecting the occurrence of an event, the control unit 11 of the vehicle 10 causes the storage unit 12 to store position information (hereinafter, also referred to as a point cloud) for a predetermined period of time before and after the occurrence of the event (S05). In addition, the control unit 11 of the vehicle 10 determines whether the geofence area A2 exists in the mesh A1 including the present position in response to detecting the occurrence of the event (S06). At this time, the control unit 11 of the vehicle 10 performs the determination according to the determination received in S03. In response to the presence of the geofence area A2, the control unit 11 of the vehicle 10 extracts the minimum longitude, the maximum longitude, the minimum latitude, and the maximum latitude from the point group (S07). The extracted minimum longitude, maximum longitude, minimum latitude, and maximum latitude are hereinafter referred to as “four points”. The control unit 11 of the vehicle 10 transmits a request to allow upload of the imaging data corresponding to the event to the server 30 (S08). The upload permission request includes information about four points extracted by S07.

In addition, when the control unit 31 of the server 30 receives a request for permitting upload of the imaging data corresponding to the event from the vehicle 10, the control unit generates the traveling area A3 corresponding to the four points (S09). As described in FIG. 2, the traveling area A3 is generated to be a rectangle including four received points. Further, the control unit 31 of the server 30 determines whether there is an overlap between the traveling area A3 and the geofence area A2 (S10). At least a part of the traveling area A3 and at least a part of the geofence area A2 may overlap with each other. At this time, for example, it may be determined whether there is an overlap by determining whether each side defining the traveling area A3 intersects with each side defining the geofence area A2.

Then, when there is an overlap, the control unit 31 of the server 30 transmits, to the vehicle 10, a notification that the upload of the imaging data is not permitted. On the other hand, when there is no overlap, the control unit 31 of the server 30 transmits a notification permitting upload of the imaging data to the vehicle 10 (S11).

The control unit 11 of the vehicle 10 uploads the imaging data corresponding to the event to the server 30 in response to receiving a command to allow uploading of the imaging data corresponding to the event from the server 30 (S12). At this time, the vehicle ID, the user ID, the event generation position, the event type, and the imaging data are transmitted to the server 30. Instead of the event type, the detection value of the sensor group 16 may be transmitted to the server 30. On the other hand, the control unit 11 of the vehicle 10 does not upload the imaging data corresponding to the event to the server 30 in response to receiving a notification that the upload of the imaging data corresponding to the event is not permitted from the server 30. In this case, the imaging data corresponding to the event stored in the storage unit 12 may be deleted. The control unit 31 of the server 30, which has received the imaging data corresponding to the event from the vehicle 10, stores the imaging data together with other information in the vehicle information DB 321 (S13).

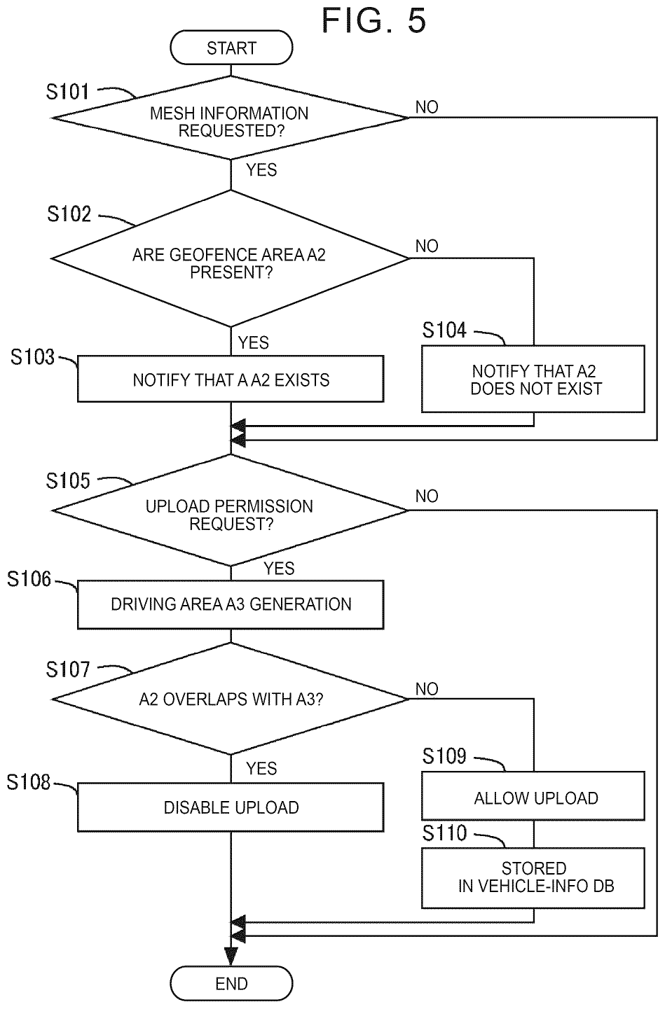

FIG. 5 is a flowchart illustrating a process executed in the server 30 according to the first embodiment. The flowchart illustrated in FIG. 5 is executed at predetermined time intervals for each vehicle 10. In S101, the control unit 31 of the server 30 determines whether a request for mesh-information has been received from the vehicle 10. If the control unit 31 makes an affirmative determination in S101, the process proceeds to S102, and if it makes a negative determination, the process proceeds to S105. In S102, the control unit 31 of the server 30 determines whether the geofence area A2 exists in the mesh A1 including the present position of the vehicle 10. If the control unit 31 makes an affirmative determination in S102, the process proceeds to S103, and if it makes a negative determination, the process proceeds to S104. In S103, the control unit 31 of the server 30 transmits a notification that the geofence area A2 exists in the mesh A1 to the vehicle 10. On the other hand, in S104, the control unit 31 of the server 30 transmits a notification that the geofence area A2 does not exist in the mesh A1 to the vehicle 10.

In addition, in S105, the control unit 31 of the server 30 determines whether or not a request to allow upload of the imaging data corresponding to the event has been received from the vehicle 10. If the control unit 31 of the server 30 makes an affirmative determination in S105, the process proceeds to S106, and if a negative determination is made, the routine ends. In S106, the control unit 31 of the server 30 generates the traveling area A3 corresponding to the four points included in the upload permission request received from the vehicle 10. In S107, the control unit 31 of the server 30 determines whether there is an overlap between the traveling area A3 and the geofence area A2. If the control unit 31 of the server 30 makes an affirmative determination in S107, the process proceeds to S108, and if the determination is negative, the process proceeds to S109.

In S108, the control unit 31 of the server 30 transmits a notification that the upload of the imaging data is not permitted to the vehicle 10. On the other hand, in S109, the control unit 31 of the server 30 transmits a notification for permitting upload of the imaging data to the vehicle 10. In S110, the control unit 31 of the server 30 stores the vehicle information received from the vehicle 10 in the vehicle information DB 321.

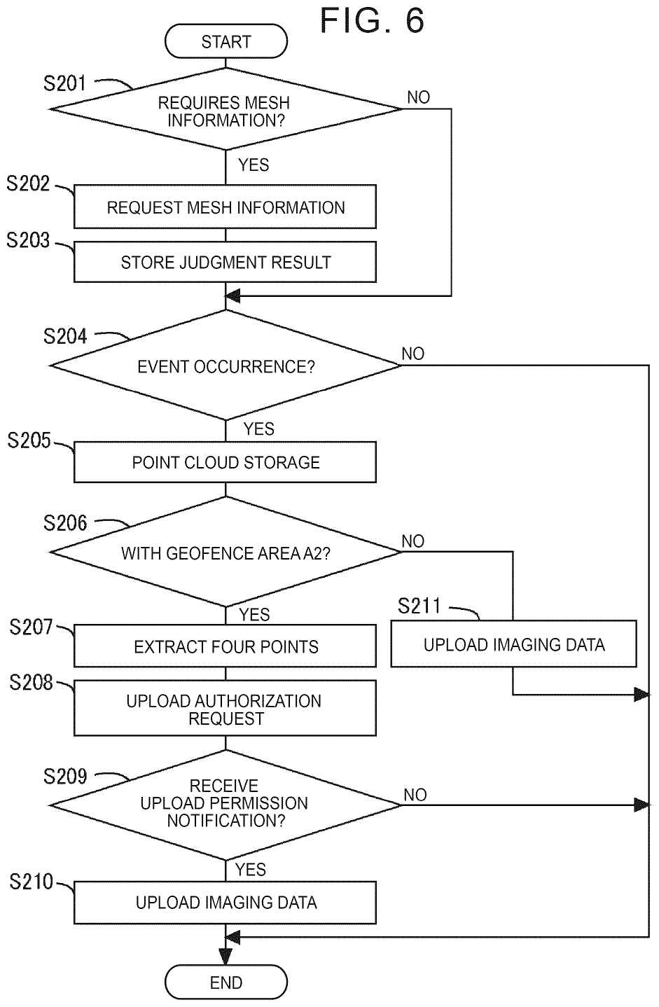

FIG. 6 is a flowchart illustrating a process executed in the vehicle 10 according to the first embodiment. The flowchart illustrated in FIG. 6 is executed at predetermined time intervals. In S201, the control unit 11 of the vehicle 10 determines whether mesh-information needs to be acquired. For example, the mesh information is updated at a predetermined cycle. Therefore, the control unit 11 of the vehicle 10 determines whether it is time to update the mesh information. If the control unit 11 makes an affirmative determination in S201, the process proceeds to S202, and if it makes a negative determination, the process proceeds to S204. In S202, the control unit 11 of the vehicle 10 transmits a message to the server 30. In S203, the control unit 11 of the vehicle 10 stores the mesh-information received from the server 30 in the storage unit 12.

In S204, the control unit 11 of the vehicle 10 determines whether an event has occurred. The control unit 11 of the vehicle 10 determines whether an event has occurred based on the detection value of the sensor group 16. The detection value of the sensor group 16 corresponding to the occurrence of the event is stored in the storage unit 12 in advance. In addition, the detection value of the sensor group 16 corresponding to the type of the generated event is also stored in the storage unit 12 in advance. The detection value of the sensor group 16 corresponding to the type of event may be stored in the storage unit 32 of the server 30. Then, the detection value of the sensor group 16 may be transmitted from the vehicle 10 to the server 30, and the type of the event generated by the control unit 31 of the server 30 may be specified. If the control unit 11 makes an affirmative determination in S204, the process proceeds to S205, and if a negative determination is made, the routine ends.

In S205, the control unit 11 of the vehicle 10 causes the storage unit 12 to store the point group. That is, the control unit 11 stores the position information of the predetermined time before the occurrence of the event and the position information of the predetermined time after the occurrence of the event in the storage unit 12. Each piece of position information includes corresponding time information. In S206, the control unit 11 of the vehicle 10 determines whether the geofence area A2 exists in the mesh A1 including the present position of the vehicle 10. This determination is made in accordance with the determination result stored in the storage unit 12 in S203. If the control unit 11 makes an affirmative determination in S206, the process proceeds to S207, and if it makes a negative determination, the process proceeds to S211.

In S207, the control unit 11 of the vehicle 10 extracts four points that are the minimum longitude, the maximum longitude, the minimum latitude, and the maximum latitude from the point group stored in S205. Further, in S208, the control unit 11 of the vehicle 10 transmits an upload permission request to the server 30. This request includes information about four points. In S209, the control unit 11 of the vehicle 10 determines whether an upload permission notification has been received from the server 30. If the control unit 11 makes an affirmative determination in S209, the process proceeds to S210, and if a negative determination is made, the routine ends. That is, when the control unit 11 makes a negative determination in S209, the control unit 11 does not upload the imaging data.

In S210, the control unit 11 of the vehicle 10 uploads the imaging data to the server 30. Also in S211, the control unit 11 of the vehicle 10 uploads the imaging data to the server 30. That is, when the geofence area A2 does not exist in the mesh A1, the imaging data is uploaded. Note that the control unit 11 may transmit metadata instead of uploading the imaging data.

As described above, in the present embodiment, the traveling area A3 is generated on the basis of four points that are the minimum value of longitude, the maximum value of longitude, the minimum value of latitude, and the maximum value of latitude among the time-series position information in a predetermined time before and after the occurrence of an event in the vehicle. It is determined whether there is an overlap with the geofence area A2. Therefore, the process can be simplified as compared with a case where it is determined whether each of the positions acquired at the time of the event is included in the geofence area A2. In addition, the amount of information transmitted from the vehicle 10 to the server 30 can be reduced.

### Other Embodiments

The above-described embodiment is merely an example, and the present disclosure may be appropriately modified and implemented without departing from the scope thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

In the above-described embodiment, the meshing data is transmitted from the server 30 to the vehicle 10 in advance as shown in S203 from S201 of FIG. 6, but this process is not essential. For example, the processes of S203, and S206 from S201 can be omitted. Then, in S208, the control unit 11 of the vehicle 10 may transmit the upload permission request including the four points to the server 30.

In the above-described embodiment, as shown in S207 of FIG. 6, the control unit 11 of the vehicle 10 extracts four points, but this process may be performed by the control unit 31 of the server 30. Here, S207 process can be omitted. Then, in S208, the control unit 11 may transmit the upload permission request to the server 30 together with the respective pieces of position information corresponding to the point cloud. Then, in S106 of FIG. 5, the control unit 31 of the server 30 may generate the traveling area A3 based on the respective pieces of position information corresponding to the point cloud.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include any types of disks, such as magnetic disks (floppy disks, hard disk drives (HDD), etc.), optical disks (CD-ROM, DVD disks, Blu-ray disks, etc.). Non-transitory computer-readable storage media include read only memory (ROM), random access memory (RAM), EPROM, EEPROM, magnetic cards, flash memory, optical cards, any type of media suitable for storing electronic instructions.

What is claimed is:

1. An information processing device comprising a control unit configured to transmit a notification to permit upload of captured image data corresponding to an event to a vehicle in response to there not being an overlap between a rectangular travel area and a geofenced area, the travel area including a minimum longitude value, a maximum longitude value, a minimum latitude value, and a maximum latitude value among time-series position information for a predetermined time before and after occurrence of the event in the vehicle.

2. The information processing device according to claim 1, wherein the control unit is further configured to transmit a notification as to whether the geofenced area is present in a mesh including a current position of the vehicle to the vehicle.

3. The information processing device according to claim 1, wherein the control unit is further configured to generate the travel area as an area defined by a longitude line passing through the minimum longitude value, a longitude line passing through the maximum longitude value, a latitude line passing through the minimum latitude value, and a latitude line passing through the maximum latitude value.

4. A system comprising:
a vehicle including a first control unit; and
a server including a second control unit, wherein:
the first control unit is configured to
extract four points with a minimum longitude value, a maximum longitude value, a minimum latitude value, and a maximum latitude value, among time-series position information for a predetermined time before and after occurrence of an event, in response to the occurrence of the event,
transmit a request for permission to upload captured image data corresponding to the event to the server, together with information about the extracted four points, and
upload the captured image data to the server in response to receiving a notification of permission to upload the captured image data from the server; and
the second control unit is configured to
determine whether there is an overlap between a rectangular travel area including the four points and a geofenced area in response to receiving a request for permission to upload the captured image data from the vehicle, and
transmit a notification of permission to upload the captured image data corresponding to the event to the vehicle in response to an absence of the overlap.

5. The system according to claim 4, wherein:
the first control unit is configured to
request the server for information as to whether the geofenced area is present in a mesh including a current position of the vehicle, and
extract the four points in response to receiving a notification that the geofenced area is present in the mesh including the current position of the vehicle from the server; and
the second control unit is configured to
determine whether the geofenced area is present in the mesh including the current position of the vehicle in response to receiving a request for information as to whether the geofenced area is present in the mesh from the vehicle, and
transmit a notification that the geofenced area is present to the vehicle in response to determining that the geofenced area is present in the mesh.
